(19) United States
(12) Patent Application Publication
(10) Pub. No.: US 2007/0014399 A1
(43) Pub. Date: Jan. 18, 2007

(54) High assurance key management overlay

(76) Inventors: Edward M. Scheidt, McLean, VA (US); C. Jay Wack, Clarksburg, MD (US); Wai Tsang, Falls Church, VA (US)

Correspondence Address: IP STRATEGIES, 12 1/2 WALL STREET, SUITE I, ASHEVILLE, NC, 28801, US

(21) Appl. No.: 11/182,499

(22) Filed: Jul. 15, 2005

(51) Int. Cl. H04L 9/00

(52) U.S. Cl. 380/44

(57) ABSTRACT

A key management overlay system includes a first key management system that produces a first cryptographic key, a second key management system that produces a second cryptographic key, and a math module that implements a math model that generates a third cryptographic key based at least in part on the first and second cryptographic keys. A key management overlay process includes generating a first cryptographic key according to a first key management system, generating a second cryptographic key according to a second key management system, and generating a third cryptographic key based at least in part on the first and second cryptographic keys.

### FIELD OF THE INVENTION

Generally, the present invention relates to a processes and systems by which an encryption scheme can take advantage of different functionalities and trust models provided by two or more key management architectures.

### BACKGROUND OF THE INVENTION

Currently, many systems exist for providing data security and access control. These and other systems typically use cryptography to enforce access, authentication, and other security parameters. Typical cryptography systems function through the use of cryptographic keys, which are created and applied through the use of a key management system. Different key management systems are based on different trust models, and therefore the goals of and advantages provided by different systems can vary. In some cases, it would be beneficial to combine certain advantages of the trust models of different key management systems.

For example, a first key management system might provide high granularity and role-based access to content, while another might emphasize immediate control or change of status. Dual function capability would allow the taxonomy of a given organization to be perpetuated throughout its information-sharing and business processes, while at the same time providing an immediate accessibility or an immediate decision point about denial of access. For example, the normal role based access to content within a bank might be immediately stopped (revoked) because an alarm is set off. As another example, the information in a hospital (HIPAA regulated patient information) might be denied on removal or reassignment of a doctor. The immediacy of control could apply, for example, to very sensitive data, or to a time constraint.

### BRIEF SUMMARY OF THE INVENTION

According to the system and process of the present invention, keys provided by a number of systems are transformed through the use of a mathematics model to provide a system key, the use of which within a trusted platform provides at least some of the advantages of both systems. This allows greater flexibility than does focusing on any one particular architecture to suit a specific application. Instead, two or more fundamental security paradigms are bound into a single crypto concept.

According to an aspect of the present invention, a key management overlay system includes a first key management system, a second key management system, and a math module. The first key management system produces a first cryptographic key. The second key management system produces a second cryptographic key. The math module implements a math model that generates a third cryptographic key based at least in part on the first and second cryptographic keys.

The first key management system can be based on a first trust model, and the second key management system can be based on a second trust model. For example, the first key management system can be a COMSEC system, and the second key management system can be an INFOSEC system. For example, the first key management system can be CKM. Similarly, the second key management system can be AES.

The first cryptographic key can be a general key used for cryptographic access to the system, and the second cryptographic key can be an ephemeral key used to control a time period during which system access is granted.

The system can also include a parametric optimization module that optimizes the first cryptographic key for compatibility with the second cryptographic key at the math module. For example, the parametric optimization module can include a lossless compression stage and an integrity process stage.

The math module can include an exclusive-OR stage.

The third cryptographic key can be a system key that includes a header and a payload that correspond to respective headers and payloads of the first and second cryptographic keys.

According to another aspect of the invention, a key management overlay process includes generating a first cryptographic key according to a first key management system, generating a second cryptographic key according to a second key management system, and generating a third cryptographic key based at least in part on the first and second cryptographic keys.

The first key management system can be based on a first trust model, and the second key management system can be based on a second trust model. For example, the first key management system can be a COMSEC system, and the second key management system can be an INFOSEC system. For example, the first key management system can be CKM. Similarly, the second key management system can be AES.

The first cryptographic key can be a general key used for cryptographic access to the system, and the second cryptographic key can be an ephemeral key used to control a time period during which system access is granted.

The process can also include optimizing the first cryptographic key for compatibility with the second cryptographic key prior to generating the third cryptographic key. For example, optimizing the first cryptographic key can include performing lossless compression and an integrity process on the first cryptographic key.

Generating the third cryptographic key can include modulo-2 addition of first and second key components corresponding at least in part to the first and second cryptographic keys, respectively.

The third cryptographic key can be a system key that includes a header and a payload that correspond to respective headers and payloads of the first and second cryptographic keys.

### BRIEF DESCRIPTION OF THE DRAWINGS

FIG. 1 is a block diagram of an exemplary basic embodiment of the system of the invention.

FIG. 2 is a block diagram of an exemplary embodiment of the system of the invention, including a parametric optimization stage.

FIG. 3 is a block diagram of an exemplary embodiment of the system of the invention, showing header and payload components of the respective keys.

FIG. 4 is a block diagram of an exemplary embodiment of the system of the invention, including a number of parametric optimization stages.

### DETAILED DESCRIPTION OF THE INVENTION

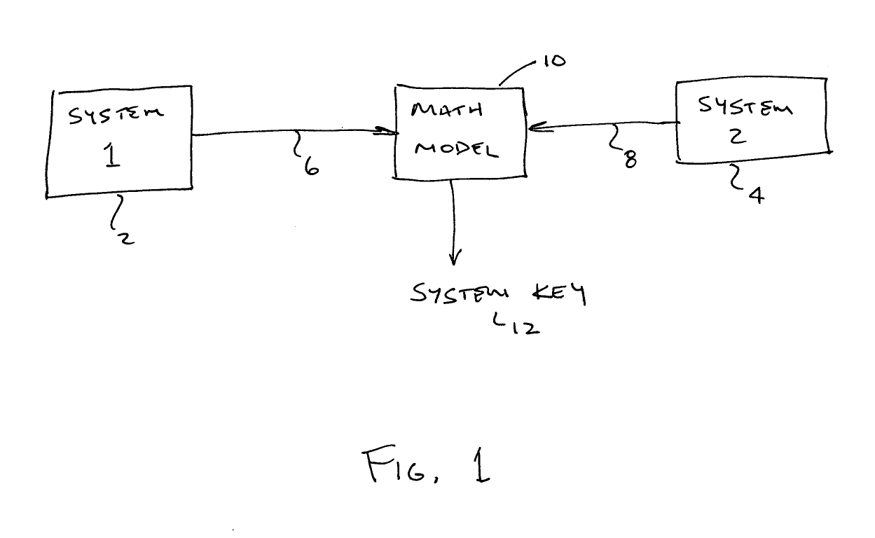

FIG. 1 shows a block diagram of an exemplary system that implements the process of the invention. According to the system and process of the present invention, keys 6, 8 provided by first and second systems 2, 4 are transformed through the use of a mathematics model 10 to provide a system key 12, the use of which within a trusted platform provides at least some of the advantages of both systems. This allows greater flexibility than does focusing on any one particular architecture to suit a specific application. Instead, two or more fundamental security paradigms are bound into a single crypto concept.

For example, a first system providing an INFOSEC access control key and a second system providing a COMSEC key offer different trust models and advantages. According to an exemplary embodiment of the invention, the COMSEC key management architecture is represented by an NSA AES encryption process, such as that described in an NSA unclassified document entitled “Keying Material Specification for 256-bit Key with Headers on Floppy”, the entirety of which is incorporated herein. The described system produces a 92-byte key identified for AES. According to the present invention, a key such as this can be transformed with, for example, a suitable INFOSEC key, by way of a proper math model to provide an enhanced key for the trusted platform.

An exemplary key management system to be used in enhancing the COMSEC key is the Constructive Key Management® (CKM®) architecture, different variations of which are described in U.S. Pat. No. 6,684,330 “Cryptographic information and flow control”; U.S. Pat. No. 6,608,901 “Cryptographic key split combiner”; U.S. Pat. No. 6,606,386 “Cryptographic key split combiner”; U.S. Pat. No. 6,549,623 “Cryptographic key split combiner”; U.S. Pat. No. 6,542,608 “Cryptographic key split combiner”; and U.S. Pat. No. 6,490,680 “Access control and authorization system”; and the following pending U.S. patent applications: Ser. No. 09/388,195 “Encryption Process Including a Biometric Input”; Ser. No. 09/858,326 “System and Method of Providing Communication Security”; Ser. No. 09/936,315 “Voice and Data Encryption Method Using a Cryptographic Key Split Combiner”; Ser. No. 10/147,433 “Cryptographic Key Split Bonding Process and Apparatus”; Ser. No. 10/194,742 “Secure Accounting and Operational Control and Reporting System”; and Ser. No. 10/278,765 “Access Control and Authorization System”; and further defineded in ANSI standards X9.69, X9.73, and X9.96, all the disclosures of which are incorporated herein in their entireties. CKM is described with more particularity below for purposes of defining the invention herein.

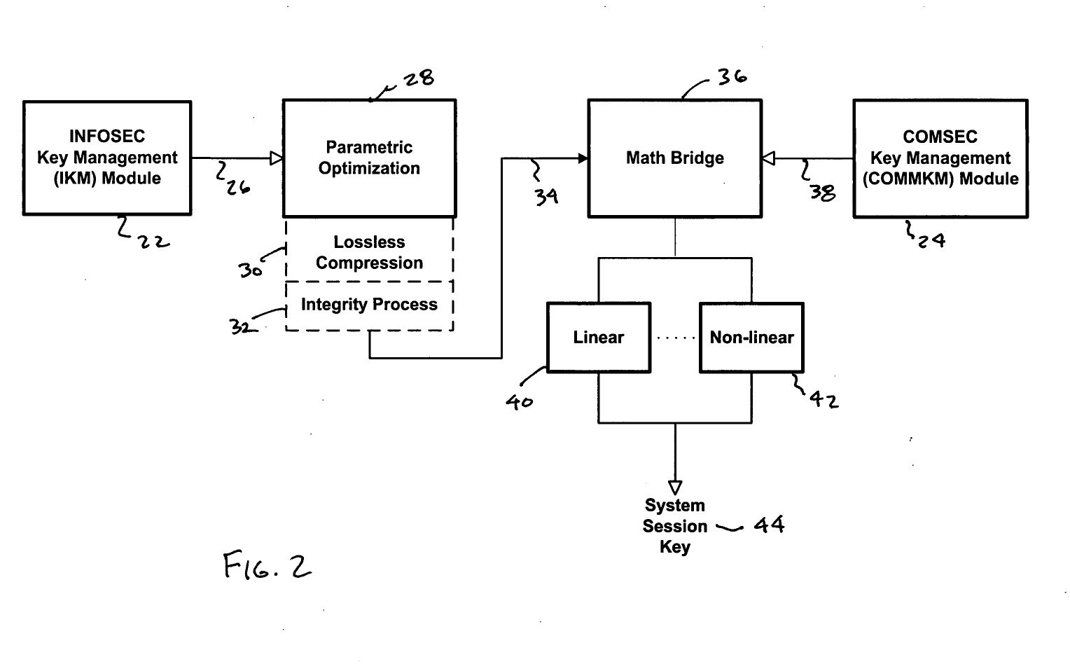

FIG. 2 shows an exemplary key structuring system and process according to the present invention. This embodiment reflects a general approach for the overlay that bridges an INFOSEC Key Management (IKM) module 22 to a COMSEC Key Management (CommKM) module 24. To begin, an IKM module 22 is used that reflects a specific INFOSEC key management process to produce a key 26 that has a header and payload and a determined byte count. The IKM module 22 is further optimized through a parametric optimization process 28 that includes compression 30 and an integrity process 32. The goal is to directly map the output 34 of the optimization process 28 to a math bridging routine 36 that includes input 38 from the CommKM module 24. The CommKM module 24 is a predefined process that generates a key 38 that includes header and payload portions.

A lossless compression routine 30 is applied to the output 26 of the IKM module 22 to reduce the byte size so that the output 34 will map to the byte size of the output 38 of the CommKM module 24. An integrity process 32 is applied to the reduced byte-sized IKM module output. The integrity process 32 can be, for example, a hash or other non-linear function.

The math bridge 36 can be a linear 40 or non-linear 42 mapping between the output 34 of the IKM module parametric optimization 28 and the output 38 of the CommKM module 24. The result of this mapping is a system key 44 that can be used as part of a cryptographic process for the system.

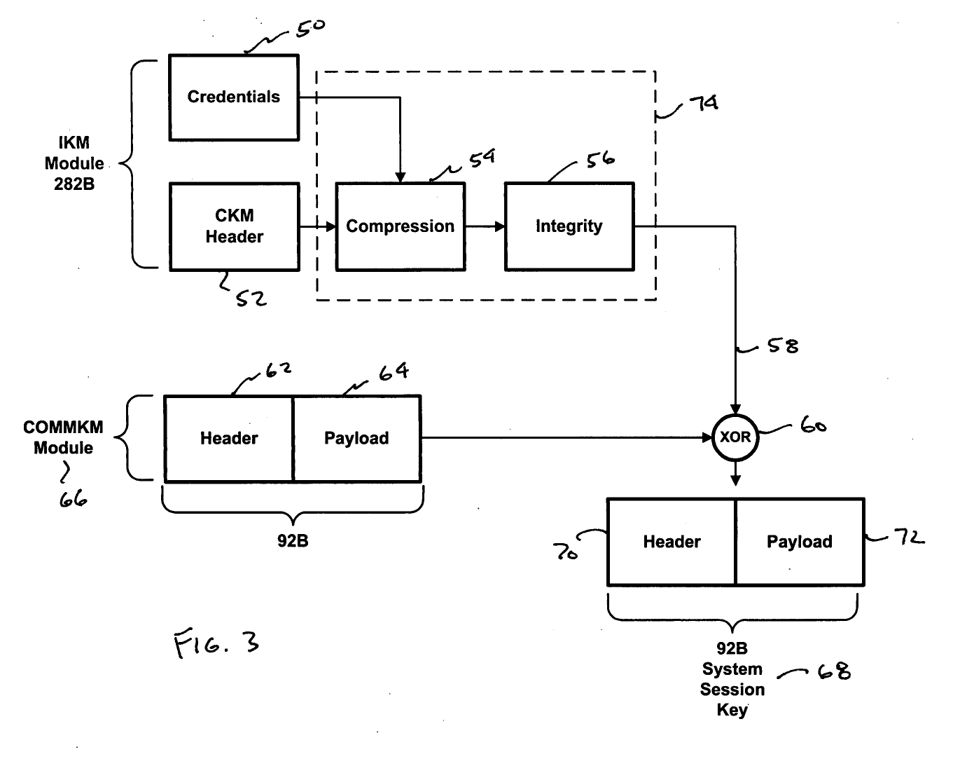

FIG. 3 shows an exemplary embodiment that includes predefined headers and payloads for the INFOSEC and COMSEC module portions. According to this embodiment, CKM is the exemplary IKM module. The basic combination of the CKM credentials 50 and CKM header 52 results in a 282-byte module. Additional credentials will increase the overall byte count. This output undergoes compression 54 and an integrity process 56 as at least part of parametric optimization 74 to produce the INFOSEC key overlay component 58, which corresponds to the INFOSEC key.

The INFOSEC key overlay component 58 can be bridged to the CommKM module through, for example, an Exclusive-OR function 60 as illustrated. The CommKM module output, which is the COMSEC key overlay component 76, consists of a header 62 and payload 64, which results in a 92-byte module 66. The resulting system session key 68 consists of a header 70 and payload 72 that is 92 bytes. Of course, both of the input keys can undergo parametric optimization, resulting in key overlay components of sizes other than 92 bytes. Further, more than two inputs from different key management systems can be optimized and then processed by the math model in order to generate the system key.

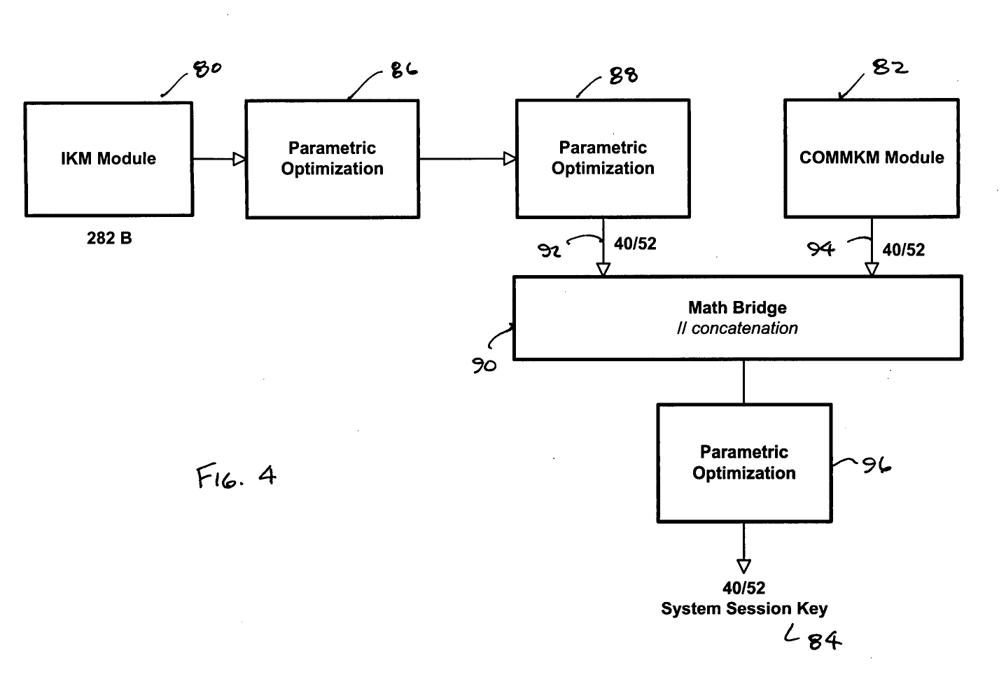

FIG. 4 shows another exemplary embodiment, in which the header and payload portions of the IKM module 80, CommKM module 82, and the system session key 84 are maintained such that they have the same byte size. As shown, parameter optimization of the IKM module 80 can be performed in more than one stage 86, 88. For example, the IKM module's header and payload can be compressed individually so that the each of the header and the payload can be directly mapped by byte size to counterparts of the CommKM module 82 and result in a directly correlatable byte count for the system session key 84.

In this particular embodiment, the math bridge 90 is a concatenation of the INFOSEC overlay component 92 and the COMSEC overlay component 94. Further optimization 96 is performed to ensure that the byte size is maintained for the header and payload portions.

Exemplary Key Management Scheme: CKM

CKM is a technology for generating and regenerating cryptographic keys, and managing those keys within an organization. A cryptographic working key is generated immediately before an object is encrypted or decrypted. It is used to initialize a cryptographic algorithm for encryption or decryption. The working key is discarded after use.

The working key is built from many pieces of information. To be a participant in the system, a user must have the pieces necessary to build the key; otherwise encryption and decryption cannot take place. A central authority generates these pieces, which are called cryptographic key splits. A subset of these splits is distributed to each user in the organization. The subset that each user receives is specific to that person and defines which labels that individual may use to encrypt (known as write permission) and which labels that individual may use to decrypt (known as read permission). Several user authentication techniques are used to verify a user to the system before that user is allowed access to this information.

To build a key, a constant system wide-split, called the organization split, and a variable system wide split, called the maintenance split, are used. To this are added a random number, which is called the random split, and user-selected label splits. The random split ensures that a unique working key is created for each use. User selected label splits define the “readership” of the encrypted object, that is, which users will be able to decrypt the object. All of these splits are input to a process known as the combiner process. The output of the combiner process is a unique number that is used as the basis for the session key.

CKM uses a hierarchical infrastructure to manage the distribution of information necessary for software to construct cryptographic keys. This infrastructure also provides a method of user certificate and public key distribution for asymmetric key cryptography so that digital signatures can be used.

CKM Infrastructure

CKM is preferably structured as a three-tiered hierarchical system. The top tier is a process identified as the Policy Manager. This process enables the “central authority” for the encryption domain to generate splits, for example, 512 random bits, to be used in key generation. Splits are labeled and are used in combination by users to generate cryptographic keys.

The next tier in the hierarchy is a process identified as the Credential Manager. This process is given a subset of labels and specific algorithms and policies from the Policy Manager. Individuals are allocated use of specific labels and algorithms from the Credential Manager's subset. Organizational policies and system parameters generated by the Policy Manager are added to these labels, forming an individual's credentials. A user's credentials are encrypted and distributed to that user on a “token”, such as a diskette or a smart card, or installed on a workstation or server. The process of label and algorithm allocation by the Credential Manager allows an organization to implement a “role-based” system of access to information.

As a convenience to the Credential Managers, password Supervisors can securely distribute “first use” passwords to users that will unlock user credentials the first time they are used.

Access to user credentials is controlled at the user tier of the hierarchy with a password that is initially assigned by the Credential Manager. The password is changed at the time of first use by the user and is known only to the user. This provides rudimentary user authentication. Stronger authentication is provided by enhancements to the system.

User authentication enhancements include a smart card—a processor and memory packaged into a plastic card or other token, like a credit card—that can hold pieces of information for user authentication. It can also retain information for use by the system and provide processing for the system. A smart card with tamper resistance and hardware random number generation capability offers additional security.

Another authentication enhancement is the use of biometric data. Biometric data is physiological or behavioral information that is unique to each individual and that does not change during that individual's lifetime. Furthermore, it has to be something that can be digitized and used by a computer. In addition to strong user authentication, biometric data may be used in the creation of private keys for digital signatures.

For data integrity alone, a Message Authentication Code (MAC) can be used. Instead of the system-generated key being used to initialize symmetric key algorithms, a generated key is used to initialize a MAC. Manipulation Detection Codes (MDCs) can also be used to provide data integrity and secrecy when combined with encryption according to CKM.

If data origin authentication, data integrity, and non-repudiation are required, then the system infrastructure is used to provide the means to distribute public keys which give CKM the ability to use cryptographic-bound digital signatures. If a digital signature is used, MACs or MDCs are not required. Combining digital signatures with the basic design and adding user authentication enhancements establishes the means to meet the security objectives stated above.

CKM Combiner Function and Splits

The combiner is a non-linear function that receives multiple inputs and produces a single integer. The integer output is used as the session key for encrypting and decrypting objects.

The starting point for the combiner function is the organization split. Everyone in the organization has access to this split. It is equivalent to what is usually called the system key.

During encryption, a user will choose one or more label splits to be used in the combiner process. This will define the authorized readership of the encrypted object, as only those who have read access to splits used for encryption will be able to decrypt the object. The selection and usage of an organization's labels by users should be taken into account in designing the label set. Good label set design should mirror an organization's established information compartments. Access to labels that can be provided to a user by a Credential Manager based on the role of that user within the organization.

It is also possible, at either the Credential Manager or Policy Manager level, to specify mandatory use labels for a specific user or group of users. These correspond to label splits that are always used when the user encrypts an object. The user has no choice in their selection—they are used automatically in the combiner.

A random split, generated for each encryption, is another split that is provided as an input to the combiner function to make the final working key. Because a new random split is generated at each encryption, the working key is always changing. It will not be the same even if the same object is encrypted again using the same labels. The random number preferably is provided by a hardware-based random number generator. However, if hardware is not available or practical, a software-based pseudo-random number generator can be used.

The maintenance split is used for key updating and compromise scenarios. The organization's policy may require that one of the splits be periodically changed. The maintenance split is changed in order to make an organization-wide impact. The Policy Manager can periodically generate a new maintenance split that is distributed to users via credentials file updates. Generation of the maintenance split is done in such a manner that all the previous maintenance splits can be recovered. Thus, for data-at-rest architectures, previously encrypted data can be recovered. For data-in-transit architectures, such as encrypted network traffic, there is no need to recover previous maintenance splits.

The maintenance split can be used to exclude someone from the organization domain. If an individual does not have credentials that have been updated with the new maintenance split, then that individual will not be able to decrypt objects that have been encrypted using this new maintenance split. Updating the maintenance split will also protect encrypted data if a user's credentials have been compromised.

In summary, the organization split is a constant number used in all encryption. The maintenance split is used to maintain a periodic change to the working key's input. The user selects label splits, and the random split is always unique, thus ensuring that every encrypted object has a different key.

Cryptographic Algorithms

CKM, with its pre-positioned splits in user credentials, provides key management for symmetric key cryptographic algorithms. The impact of the classical n-squared key management problem has been lessened without resort to asymmetric or “public-key” cryptographic systems. However, the infrastructure provided for the private key management solution can also be used for public-key management. Asymmetric key cryptosystems are used by CKM for message authentication and can be used for user credential distribution and for key exchange for the communications protocol between workstation and smartcard.

Preferably, a minimum of two symmetrical key algorithms are provided for use with CKM—for example, P², (a stream cipher algorithm) and the U.S. Data Encryption Standard (DES) algorithm, a block cipher algorithm. Other algorithms are available subject to business considerations, such as United States export regulations and license agreements.

For the DES block algorithm, four different operating modes are provided—Electronic Code Book (ECB), Cipher Block Chaining (CBC), Output Feedback (OFB) and Cipher Feedback (CFB). In addition, CFB is offered in 1-bit, 8-bit, or n-bit feedback where n is the block size (or integral division of block size). Output feedback is also available in counter mode.

Triple encryption is also available for every block algorithm, subject to export regulations. This means that not only triple DES is available but also, for example, triple IDEA, triple RC5, etc. can be used. As with all block algorithms, the four stated operating modes are available. There are additional operating modes available with triple encryption and decryption.

The Policy Manager may rename an algorithm and operating mode. Different algorithms can be put to use for different purposes and an algorithm's name may reflect its use. The names of the algorithms that a user has permission to use are contained in the user's credentials. Since the Policy and Credential Managers control access to algorithms, applying different algorithms has the effect of further compartmenting access to encrypted data.

Symmetric key algorithms are used by CKM for encrypting objects. They are also used internally by processes of CKM, such as in the combiner. Asymmetric key cryptographic systems may also be used by CKM for message authentication, credential distribution, and the key exchange protocol between smart card and workstation.

A biometric reading can provide the basis for a user's private key used for message authentication. In this case, the private key need not be stored since the user can recover it by taking the biometric reading. The public key used for authentication is usually derived from this private key and is stored in the user's Credential Manager's database. To base the private key on a biometric reading requires special properties regarding the biometric. Normally, these special properties do not apply, in which case the private key will need to be generated by the user and stored, usually on a user's workstation or smartcard. A secure backup is needed for this private key in case of loss. Note that the Credential Manager preferably will not have access to a user's private key used for authentication.

The public-key pair for each user that is used for credential distribution is generated and stored by the Credential Manager. Since these key pairs are used only to encrypt information from the Credential Manager to the user, the private key does not have to remain unknown to the Credential Manager. Thus, the Credential Manager stores both the public and the private keys for its users in its database. User's public keys are used to encrypt the key used to encrypt user credentials for distribution. The Credentials Manager stores user's private keys only for backup purposes. Users must have their own copy of their private key so they can decrypt their credentials when received.

Asymmetric key systems are also used for exchanging a session key between a system-enabled smart card and a workstation. On installation of system software, a public and private key pair is generated by the workstation and by the smart card for this purpose. A station-to-station protocol, for example ISO9798-3 using mutual authentication with random numbers, is used to exchange a session key that is used to encrypt the communications between the smart card and the workstation.

CKM User Credentials

User credentials, contained in computer files, include a user's permission set, that is, the label splits, their associated label names and indices that can be used for encryption (write permission) and decryption (read permission), and the permissions to algorithms that may be used. In addition, the organization name and associated split, maintenance level and associated split, header encryption split, and certain parameters to be used by the organization are contained in a user's credentials. Policies, such as minimum password length, are also included in the user's credentials. When digital signatures are used, a copy of all the organization's Credential Manager's public keys are included, as well as the user's signed certificate.

In assigning a permission set to a user, the Credential Manager looks to that user's role and its related responsibilities and privileges within the organization. Role templates and role hierarchies in the Credential Manager software aid the Credential Manager in this job. An individual's role may change; hence, credentials can be reissued with different labels, or can even be revoked altogether for an individual who has left the organization.

User credentials are encrypted and must be decrypted by each user before use. Decrypting the credential file is the basis for cryptographically identifying the user. The key used for encryption and decryption is derived from the user's ID, as is a password that only the user knows. Some unique data, such as a date/time stamp associated with the file, or a random number residing in a place different from that of the credentials file is also used. Every time the credentials file is decrypted for use, it is re-encrypted using different data. Since this data is always changing, the credentials file is encrypted with a different key after every use. This increases the work that an adversary must perform to break a user's credentials. Since a piece of information other than a password is used, an adversary must determine this unique data before a password-guessing attack can take place.

When a smart card is used, a random number can be stored on the smart card. This has the effect of tying the user and the smart card to the credentials file. In this case the credentials file cannot be decrypted without the smart card.

When biometrics is used, the biometric reading offers another piece of information from which to derive the credentials file encryption key if the reading can be reproduced exactly each time. This further ties the user to the credentials file. However, if the biometric reading cannot be reproduced exactly each time, it must be compared to a stored baseline template for variance calculation purposes. In this case, the template is not used in the encryption of the credentials. Instead, it is used for authentication and is carried in the credentials where it is used to compare to each biometric reading.

The credentials file carries an expiration date. Beyond this date the credentials file is useless. Each encrypted object contains a time stamp in its header. Objects encrypted by others beyond the expiration date of the credentials cannot be decrypted. The maximum time-out value, that is, the time from credentials issuance to credential expiration, is set by the Policy Manager. A Credential Manager may further restrict the time-out but cannot extend the time-out value when issuing credentials to a user. To use the system of CKM after credentials have expired, a user must have credentials reissued by that user's Credential Manager.

On issuance or re-issuance of a credentials file, the Credential Manager software generates a new “first-use” password. Before the new credentials can be used for the first time, the “first-use” password must be used to decrypt the credentials and then a new password must be provided for subsequent encryption and decryption of credentials.

The “first-use” password is generally transmitted to the user using a different communication channel than that used to transmit the credentials file. An asymmetric key cryptographic algorithm may be used to encrypt a “first-use” key. A private key provided by the Credential Manager is used to recover this “first-use” key and decrypt the credentials.

When biometrics is used in the encryption of the credentials file, the user's public key is contained in the credentials and will be used as a check. Only the correct biometric reading will produce a private key that generates a public key that matches the one in the credentials.

To be able to encrypt, decrypt, sign, and verify objects, a user must have credentials. They provide most of the “secret” information needed for these actions and are tied to a user with strong authentication techniques when the full system is used. A user's access permissions may be revoked by taking away that user's credentials or by allowing them to expire without renewal. If credentials are required to be stored on a server, then a user's credentials may be removed immediately. Once the Policy Manager issues a new maintenance split, user credentials that have not been updated are useless for any data encrypted after this update—a further means to force a user off the system.

The CKM Header

Every encrypted object contains added information, preferably in a header. This information is needed to decrypt the object. It contains, as a minimum, an index to the label splits and the algorithm used in the encryption process, the organization name, the maintenance level pointing to the maintenance split to be used, and the random split. The random split is encrypted by using an encryption key based on the same label splits used to encrypt the object. To be able to recover the random split, a user must have read access to the label splits that were used in encrypting the object. The organization split, maintenance split, and label splits that are contained in a user's credentials, along with the random split recovered from the header, allow the encryption key to be recovered. The object may then be decrypted.

Also contained in the header is a time stamp indicating the date and time the object was encrypted. CKM will not allow a user with credentials that have expired before this date to decrypt the object.

The ID of the user who encrypted the object, as well as the identity of that user's Credential Manager, is contained in the header. If a digital signature is used, it is contained in the header along with the user's certificate. With the appropriate Credential Manager's public key, all of which are contained in each user's credentials, the certificate can be decrypted to recover the signing individual's public key. This public key is used to verify the digital signature once the message is decrypted.

Most of the header itself is encrypted using a constant header split. The intent of using this split is not security. This is a step to discourage anyone from trying to break the system by preventing easy initial success. All information in the header is either public, or in the case of the random split, encrypted within the header.

Data contained in the header can offer a basis for certain types of information searches and database queries. Search engines could contain logic to look at the header to provide data separation. Since decrypting the header does not reveal message contents, a process may be placed on network monitoring and control devices to check traffic for verification, integrity, routing, etc. without revealing the encrypted data. For example, label information contained in the header can be the basis for keeping encrypted data confined to a network by having routers prevent data with particular labels from crossing certain network boundaries. Thus, by using the header, CKM lends itself to managing and encrypting data-in-transit over a network, as well as static data-at-rest.

Data Separation

Data separation is the process of assigning data to and restricting access to each category based on need-to-know. One way of accomplishing this is by physically placing data where unauthorized people cannot access it. However, providing physically separate networks or machines to host different sets of data is costly. CKM provides a way of separating data so those with authority will have access to it without having to physically keep the data confined to different networks, hard disk drives, servers, etc.

CKM Key Recovery

Key recovery is an organized process to regenerate the encryption key requiring several deliberate events, plus access to the encrypted object. The Policy Manager can initiate this process and provide any Credential Manager with all label splits required. The Credential Manager is able to provide credentials with read capability for label splits that were used to encrypt the object.

Note that an expiration date is set for credentials files. It is possible for the Credential Manager to create a credentials file that is valid for only one day. For example, pursuant to a judicial order, law enforcement may be issued read-only splits to recover information they need. They would not be able to recover information encrypted subsequently.

Another reason to use key recovery would be for recovering data encrypted by an employee that has left the organization, died, or who has become incapacitated. The loss of an individual does not mean that data encrypted by that individual cannot be recovered.

If a user's original credentials are lost or the password is forgotten, CKM can recreate a user's credentials. This is accomplished by simply issuing new credentials to the user. The user chooses a new password upon initial use of the new credentials. In some cases it is possible to regenerate the original private and public keys assigned to a user for authentication.

CKM User Authentication Enhancements

Strong user authentication requires something that an individual knows, something possessed by the individual, and something that individual is. Passwords, something known, are used for rudimentary user authentication. Smart cards (or other tokens) are something possessed. Biometric data is something an individual is. Any combination of all three may be used in the system of CKM.

Smart Cards

Smart cards can be used to hold key pieces of information according to the process of CKM. A random number stored on the card can be used as a piece of information in building the key to encrypt each user's credentials. This ties the smart card to the credentials. Without the number stored on the card, decryption of a user's credentials is not possible. The user needs the card to complete session establishment before the system can be used. Other pieces, such as a password, are still needed to log on to the system. The smart card alone is not sufficient to start a session, thus defeating an adversary who has stolen or otherwise acquired a user's smart card.

User credentials can be stored on the smart card. This would let the user travel to other machines that are not part of the organization's main network and still be able to use the system.

Security is enhanced by keeping decrypted user credentials in the smart card's memory only for the duration of a session, as well as by running the combiner process on the smart card's processor. Local processing within the card increases the workload of an adversary who is attempting to view the internal workings of processes in order to gain information about secret keys.

The SuperCard™

The SuperCard™ is an ISO-compliant smart card that has enhanced processing ability and greater memory than current smart cards. It includes tamper resistance and hardware random number generation. The processing capability internal to the card can be used to reduce task processing on the workstation. Even though the bandwidth between the card and the workstation is limited, with the system of CKM only small amounts of data are transferred between the two. Larger memory within the card also makes it possible to store user credential files, as well as “private” applications.

To keep “secret” information, such as splits, from being revealed to someone monitoring communications between the card and the workstation, the communications between the SuperCard™ and the workstation are encrypted. The key agreement protocol used to exchange the encryption key is between the card and the workstation. No additional intelligence is required in the card reader.

An inherently random radio frequency signature, called Resonant Signature-Radio Frequency Identification (RS-RFID), which is provided by tangents embedded within the card, aids tamper resistance. The digital representation of the RS-RFID of the card is contained within a user's credentials file and is encrypted with the credentials. Any tampering with the card will change the RS-RFID of that card. When the damaged RS-RFID is used, the wrong radio signature is read and will not compare to the decrypted value of the RS-RFID from the user's credentials file. Thus, tampering with the card will be detected. The card reader that reads the SuperCard™ contains hardware to read the RS-RFID signature. In addition, the SuperCard™ can be used in ISO-standard card readers. In these cases the RS-RFID would be ignored and tamper evidence would not be provided.

Random numbers are needed for object encryption and other operations. In the absence of hardware random number generation, the system resorts to a software pseudo-random number generator. A feature provided with the SuperCard™ is hardware random number generation capability. Using the hardware source provides much better random number generation and contributes to the strength of the overall security of the system.

Biometric Data

The process of using a biometric device can generally be described as follows: Initially, a biometric reading taken from the device is digitized; the digital representation is mathematically transformed, and then is stored somewhere as a template. Subsequent biometric readings are compared to this template for verification. Biometric readings can also be used for identification by comparing a biometric reading to templates stored in a database. A match from this database establishes identification. CKM uses biometrics only for verification during session establishment.

In general, biometric readings will vary by a small amount. A variance from the template value is allowed and is set according to the application and security requirements. This variance is an adjustable factor calculated from the false-success and the false-rejection rates.

Most biometrics can only give a “yes or no” answer to the template comparison. If higher false-success rates can be tolerated, mathematical techniques applied to some types of biometric readings can be used to transform the reading into a repeatable number that can be matched exactly to a stored template. With a repeatable number, biometric data can be provide the system with information used to derive keys used in symmetric and asymmetric key cryptosystems.

It is desirable not to store a biometric reading, including the biometric template, even if it is encrypted. If a repeatable number can result from biometric readings, these biometric values can be used as a piece of data to build the key to unlock user credentials. They can also be used as the basis for the private key in asymmetric key systems used for message authentication.

During user verification, on decryption of the credentials file using a biometric value, the user ID field in the decrypted credentials file is compared to the ID typed by the user. If the comparison is favorable, the user has been authenticated and the data in the credentials file has been decrypted correctly. Biometric data as part of the key used in encrypting a user's credentials file ties that user to the credentials.

Since other pieces of information, such as a password, user ID, and other data, such as a random number, are used to create credentials encryption key, higher false-success rates from the biometric can be tolerated. Even if two people generate the same biometric value, the credentials encryption key would not be the same for the two since their user IDs and passwords, as well as ephemeral data, are not the same.

A user's private key for digital signatures can be based on the user's repeatable biometric template. A user's public key is generated from the private key. The public key is recorded in the user's Credential Manager's user database as part of the enrollment process. Requiring the user to be present for enrollment establishes identity but other acceptable methods establishing identity can be used.

When repeatable biometrics readings are used, a user's private key, although not stored, is recoverable if lost. In this case a biometric reading would establish the private key and generation of the corresponding public key may be checked against that stored in the Credential Manager's database.

If a repeatable number cannot always be guaranteed from a biometric reading, then a biometric template must be stored for comparison with subsequent biometric readings. In this case the biometric template would be encrypted within a user's credentials file. During user authentication, the credentials file would be decrypted, recovering the biometric template, and then the biometric reading taken for authentication would be compared to the template and a “yes or no” answer would result.

CKM Message Authentication

Asymmetric key cryptographic systems are used in the system for the three message authentication related objectives stated above. If only data integrity is desired, message authentication codes can be used. If data integrity coupled with secrecy is required, message manipulation codes with asymmetric key encryption can be used. To meet all three message authentication objectives, while providing secrecy, digital signatures are used.

CKM Digital Signatures

Digital signatures are used to provide data origin authentication, data integrity, and non-repudiation. The infrastructure provided by the system supports a form of a Public-Key Infrastructure (PKI) that distributes signed certificates and public keys used in digital signature verification. In other proposed public-key systems, the certificate authority takes the form of a database on a server that uses query via a network. In the system of CKM, Credential Managers act as certificate authorities. All information for verifying digital signatures is provided in each user's credentials and in the encrypted objects. Additional bandwidth due to network and server processing is not required as it is in other public-key systems.

The certificate for a user is signed by that user's Credential Manager. Each Credential Manager has its own public and private key. The public keys of the organization's Credential Managers are provided in each user's credentials. The Credential Manager encrypts, that is, signs, a user's ID and public key combination with the Credential Manager's private key. This is a basic user certificate. It can be decrypted only by using the Credential Manager's public key.

A user's certificate is contained in that user's credentials so that it can be sent with objects the user has signed. The recipient of a signed object uses the Credential Manager's public key to decrypt the sender's certificate and recover that user's public key. The recovered sender's public key is then used to verify the sender's digital signatures on the signed object.

A user's biometric template, when available, can form the basis of a user's private key. For example, in the El Gamal Signature Scheme, a public key is the combination of a prime number, p, a primitive element, α, and a value, β, computed from a private number α. This private number is usually picked at random. However, in CKM, the user's biometric template could become this private number, or part of this number. Because of this, private and public keys used for authentication are tied to an individual. The public/private keys can be recovered (negating the need for storage) if a repeatable biometric value can be obtained.

Manipulation Detection Codes (MDCs)

If privacy and data integrity without regard to data origin authentication and non-repudiation are desired, an MDC combined with encryption can be used. An MDC is basically an “unkeyed” hash function that is computed from the message. This hash is then appended to the message, and the new message is encrypted.

From verification of data integrity, a recipient decrypts the message, separates the hash from the message, computes the MDC of the recovered message, and compares this to the decrypted hash. The message is accepted as authentic if the values match.

Message Authentication Codes (MACs)

If only data integrity without regard to privacy is needed, a MAC can be used. The working key for the MAC is constructed in the same way as that for the key used for encrypting a message for privacy, that is, by using the combiner process with label splits, organization split, maintenance split and a random split.

To verify data integrity, the recipient of the MACed message uses the splits associated with the message to rebuild the key for the MAC. A new MAC is then calculated by the recipient and compared to the MAC sent with the message. If the two MACs match, the message is accepted as not having been altered.

It is not expected that MDCs and MACs will be used as often as digital signatures. Therefore, MDCs and MACs will not be mentioned in the process descriptions that follow.

The CKM Process

Selected processes are described to illustrate how CKM accomplishes its tasks. It is assumed that a smart card such as the SuperCard™ and biometrics with the ability to generate a constant biometric value are used.

CKM Session Establishment (Logging On to the System)

Use of the system is contingent on successful logon and decryption of user credentials. Session establishment begins when a system-enabled program is run on a user's workstation. The workstation prompts the user to present the smart card, user biometrics, user ID, and password (logon data). An encrypted channel is established between the workstation and smart card and the logon data is transferred to the smart card where a key is generated to decrypt the user's credentials. The credentials can reside on the smart card or in some other location, in which case the encrypted credentials file would be sent to the smart card for decryption and use. On successful logon, the credentials file is re-encrypted and stored and a decrypted copy is kept in the smart card's memory for use during the session.

Note that three things are needed to complete logon—a password, a smart card (or other token), and biometric information. Without knowing the password, an adversary needs to guess or search the entire password space. Random bits are used as a start for the credential decryption process so that if password guessing is used the output could not so easily be detected by the adversary as correct. Changing these random bits continually prevents an adversary from bypassing the process by “replaying” past results. Password policies, such as minimum characters required in a password, increase security when passwords alone are used for user authentication. Passwords alone are still considered weak authentication. Smart cards and biometrics are recommended for strong authentication.

The smart card must be present to complete logon. Putting random bits for the credentials file key generation on the smart card cryptographically ties that card to the user's credentials and hence to the user. The smart card alone will not complete the logon without a user's password. The password is not stored on the smart card, and so loss of the card to an adversary does not compromise a user's password or the user's credentials.

When the SuperCard™ is used, the inherent radio frequency signature detects tampering with the card by comparing this signature to the one stored in the user's credentials. The SuperCard™ can still be used in a standard ISO smart card reader but the RS-RFID would be ignored.

Using biometric data as a piece of information to build the key to decrypt the user's credentials cryptographically ties the biometric data, and hence the user, to the credentials file. Thus, knowledge of the user's password and possession of the user's smart card will not be enough information to decrypt the user's credentials. Compromise of the password and smart card does not disclose a user's biometric data, as it is not stored on the card, or anywhere for that matter, even in an encrypted form.

Once logged on, a user will remain logged on as long as a program is actively being used and while the smart card remains in the card reader. There is a time-out value, set by the Credential Manager, beyond which if the user does not actively use an enabled program, the session is disabled. The user must then present the password and biometrics again to continue using enabled software. When a user quits an enabled program and there are no other enabled programs running at that time, the user may log off or continue to stay logged on until the time-out period has lapsed. Within this time-out period, if another enabled program is invoked, the user does not have to log on. If, however, the time-out period has lapsed, the user will have to log on again. During this period when no enabled program is running, and before the time-out value has expired, the user may run a utility program that will quickly log that user off.

CKM Encryption with Digital Signature

Encryption of objects requires the choice of a cryptographic algorithm and label splits. This choice will determine who will be able to decrypt the object. Default label and algorithm selection is provided for convenience. This streamlines the encryption process, especially when the majority of data is encrypted using the same label set and algorithm. The Credential Manager may set this default. It can be made most restrictive, in which case a user need change the label selection only to make the label set less restrictive. The splits corresponding to the user-selected and mandatory use labels are used by the combiner process to generate a key that is used to initialize the user-selected cryptographic algorithm.

A cryptographic hash is applied to the object's plaintext, that is, before the data is encrypted. The hash value is then encrypted with the user's private key (which has been generated based on the user's biometric reading), resulting in the digital signature for that object.

Digital signatures may be an option or may be mandatory depending on Policy Manager requirements.

A header is created containing the user's label and algorithm choice, the user's certificate, a digital signature and other information that might be required for decrypting the object. This header is appended to the encrypted object.

CKM Decryption with Digital Signature Verification

Decryption starts by decrypting and reading the header of an encrypted object. If the user has read permission for the labels used in encryption and has access to the algorithm used, then the object may be decrypted.

For signature verification the object must first be decrypted so that a cryptographic hash can be computed. This means that only those who have read permission for the labels used for encryption will be able to verify the digital signature. Once the hash is computed, the public key of the encryptor's Credential Manager is retrieved from the credentials. This public key is used to decrypt the certificate contained in the header, thus recovering the signatory's public key. The verification module takes the encryptor's public key, the digital signature, and the hash value that was computed from the decrypted data as input. If the verification module returns a “Yes” answer, then the object is declared as being authentic.

Detection

The intent of detection is to notify certain individuals and to take certain actions whenever events indicative of intrusion, tampering or failure have taken place. At its simplest, detection is provided with audit of selected events. The minimum events to be audited are determined by the Policy Manager.

Detection can take other forms, such as statistical tests for randomness on generated random numbers. Weak cryptographic key detection can also be performed. These types of alarms would notify or stop a user from continuing with an action that might compromise the security of the system.

An example of another technique is use of monitors that can read headers periodically, or at random, and verify the label sets contained therein against a user's issued labels per the Credential Manager's database. This would aid a security administrator to detect when someone might be trying to gain unauthorized access.

There are many techniques, some of them hardware-based, that can be used for event detection and alarm. Use of these will be controlled by the Policy Manager and the Credential Managers.

CKM Summary

CKM technology can provide an effective system for encrypting data-at-rest. It can also provide a suitable system for encrypting data-in-transit. CKM can be extended beyond the application protocol level to lower levels, such as level 2 (for example IEEE 802) in the OSI stack. The encryption protocol to establish the session key for the channel can be adapted to the parameters of the communications environment.

An application programming interface implementing CKM can be used to develop secure applications. Software can be used to provide file and e-mail encryption, incorporating selected elements of the technology described herein. CKM can also be used to add encryption to audio and graphics applications.

CKM Label Set Design

CKM uses encryption to provide selective access to information. When encrypting with CKM, users (persons or devices), manually or automatically, select labels they share with intended receivers of the information being encrypted. The user may apply as many labels as needed to target a specific subset of information or information grouping. Only users holding credentials containing matching labels will be able to view the information.

Labels are the humanly understandable counterparts of the cryptographic splits. They form the variable part of a symmetric access control system. The selection and deployment of labels are extremely important in creating a useful cryptosystem.

CKM is well suited for data separation and role-based access to information. Data separation is the process of assigning information to levels or categories and then restricting access to each based on need-to-know or other security policy. Role-based access is the method that assigns access to information by roles performed and then assigns individuals to these roles. Each individual's access to information changes as her roles change. The Internet has facilitated the creation of search engines that access information in many databases. The tagging or indexing methodology of these search engines can be correlated to labels that are included in the cryptosystem.

All information within any organization does not have the same disclosure risk. The disclosure of some information could have a serious negative impact depending on circumstances. A time-honored method to minimize unauthorized disclosures is to keep information within organizational compartments and to establish policies, procedures, and controls appropriate for each.

Labels can mirror established information compartments within an organization. For example, if a large organization has identified 500 information compartments then the Policy Manager would create 500 labels representing these compartments. Specific labels would be assigned to individuals assigned to roles with access to specific compartments. Top-down mandated information compartments simplify the process for individual users. If an individual is assigned to roles within two information compartments, then his credentials only present these two label options for encryption. In practice, however, a total mandated compartment system is not sufficiently flexible. It is best to allow each user some flexibility in designating readership restrictions for material to be sent outside mandated compartments.

Labels also can be used to designate readership across the organization. For example, the label “Personnel Information” may be issued to all persons within the organization. All persons would be able to encrypt information using this label; however, only managers and those persons assigned to the personnel department would be able to decrypt such information. Other “across the organization” labels with similar encrypt and decrypt restrictions might include Security, Legal, Inspector General, or other organizational groups or functions.

The use of templates can aid the distribution of labels. Templates can be made to include labels that represent an organization's information flow boundaries, or to represent a grouping of information subsets. By nesting templates and assigning them to numerous users at the same time, the distribution process is greatly facilitated. For example, a basic role template may be created containing the labels to be assigned to all employees. Additional templates may be created and assigned for supervisors, managers, and executives, or other roles as required.

Care must be taken to design a label set that is as limited as necessary to meet security requirements. The objective should be to combine labels representing a mandated compartment approach with labels that allow for ad hoc and cross-organizational (compartment) communications. The resulting label set will allow a simple, easy to use sub-set to be distributed to each user.

Thus, the output of the CKM process is a working key that can be manipulated with, for example, the 92-byte NSA key described above by way of a math model, such as modulo-2 addition, to provide a key that can be used in a system such as 256-bit AES. According to this example, a COMSEC key is transformed with an INFOSEC access control key, providing the receiving system with advantages provided by both architectures. If the COMSEC architecture is considered primary, the INFOSEC architecture may be looked at as a crib or subordinate extension of the primary architecture. Thus, the INFOSEC key would be a crib key for the COMSEC operational key. Accordingly, the purpose of the math bridge is not to degrade the integrity of the COMSEC key, but to offer additional functionality to the COMSEC key.

The purpose of bridging the two key management architectures is to take advantage of possible differing functionalities and differing math trust models. The selection of the math bridge must ensure that the advantages of the two architectures are maintained and that the integrity or assurance of either architecture does not degrade the assurance of the other. Although the use of more than two architectures in the general model is more complex, it is contemplated under the broadest scope of the present invention, which is not limited by any particular type or number of key management architecture or math model.

What is claimed is:

1. A key management overlay system, comprising:
a first key management system that produces a first cryptographic key;
a second key management system that produces a second cryptographic key; and
a math module that implements a math model that generates a third cryptographic key based at least in part on the first and second cryptographic keys.

2. The system of claim 1, wherein the first key management system is based on a first trust model, and the second key management system is based on a second trust model.

3. The system of claim 1, wherein the first key management system is a COMSEC system, and the second key management system is an INFOSEC system.

4. The system of claim 1, wherein the first key management system is CKM.

5. The system of claim 1, wherein the second key management system is AES.

6. The system of claim 1, wherein the first cryptographic key is a general key used for cryptographic access to the system, and the second cryptographic key is an ephemeral key used to control a time period during which system access is granted.

7. The system of claim 1, further comprising a parametric optimization module that optimizes the first cryptographic key for compatibility with the second cryptographic key at the math module.

8. The system of claim 7, wherein the parametric optimization module includes a lossless compression stage and an integrity process stage.

9. The system of claim 1, wherein the math module includes an exclusive-OR stage.

10. The system of claim 1, wherein the third cryptographic key is a system key that includes a header and a payload that correspond to respective headers and payloads of the first and second cryptographic keys.

11. A key management overlay process, comprising:
generating a first cryptographic key according to a first key management system;
generating a second cryptographic key according to a second key management system; and
generating a third cryptographic key based at least in part on the first and second cryptographic keys.

12. The process of claim 11, wherein the first key management system is based on a first trust model, and the second key management system is based on a second trust model.

13. The process of claim 11, wherein the first key management system is a COMSEC system, and the second key management system is an INFOSEC system.

14. The process of claim 11, wherein the first key management system is CKM.

15. The process of claim 11, wherein the second key management system is AES.

16. The process of claim 11, wherein the first cryptographic key is a general key used for cryptographic access to the system, and the second cryptographic key is an ephemeral key used to control a time period during which system access is granted.

17. The process of claim 11, further comprising optimizing the first cryptographic key for compatibility with the second cryptographic key prior to generating the third cryptographic key.

18. The process of claim 17, wherein optimizing the first cryptographic key includes performing lossless compression and an integrity process on the first cryptographic key.

19. The process of claim 11, wherein generating the third cryptographic key includes modulo-2 addition of first and second key components corresponding at least in part to the first and second cryptographic keys, respectively.

20. The process of claim 11, wherein the third cryptographic key is a system key that includes a header and a payload that correspond to respective headers and payloads of the first and second cryptographic keys.
